(19) United States
(12) Patent Application Publication
(10) Pub. No.: US 2021/0004005 A1
(43) Pub. Date: Jan. 7, 2021

(54) IMAGE CAPTURE METHOD AND DEVICE, AND MACHINE-READABLE STORAGE MEDIUM

(71) Applicant: SZ DJI TECHNOLOGY CO., LTD., Shenzhen (CN)

(72) Inventors: Ronghua LIN, Shenzhen (CN); Tie SU, Shenzhen (CN)

(21) Appl. No.: 17/021,946

(22) Filed: Sep. 15, 2020

Related U.S. Application Data
(63) Continuation of application No. PCT/CN2018/082410, filed on Apr. 9, 2018.

(51) Int. Cl. G05D 1/00; G06T 3/40; G05D 1/08; B64C 39/02; G06T 7/70

(52) U.S. Cl. CPC G05D 1/0094; G06T 3/4038; B64C 2201/127; B64C 39/024; G06T 7/70; G05D 1/0808

(57) ABSTRACT

An image capture method includes obtaining one or more control parameters and a shooting range, obtaining an image amount according to the one or more control parameters and the shooting range, determining shooting angles according to the shooting range and the image amount, and performing image capture according to the shooting angles.

### CROSS-REFERENCE TO RELATED APPLICATION

This application is a continuation of International Application No. PCT/CN2018/082410, filed Apr. 9, 2018, the entire content of which is incorporated herein by reference.

### TECHNICAL FIELD

The present disclosure relates to the field of gimbal, and in particular, to an image capture method and device, and a machine-readable storage medium.

### BACKGROUND

Gimbal (e.g., a handheld gimbal or the like) used for fixing a shooting device (also referred to as a “photographing device,” e.g., a camera, a video camera, or the like) has been widely used. By adjusting an attitude of the gimbal, the shooting device can shoot at different angles under different attitudes. Currently, in order to capture an image beyond a field of view of a lens, a user needs to manually rotate the gimbal, which is troublesome and time-consuming, and not able to ensure the uniformity of rotation.

### SUMMARY

In accordance with the disclosure, there is provided an image capture method including obtaining one or more control parameters and a shooting range, obtaining an image amount according to the one or more control parameters and the shooting range, determining shooting angles according to the shooting range and the image amount, and performing image capture according to the shooting angles.

Also in accordance with the disclosure, there is provided an image capture method including obtaining one or more control parameters and a shooting range of a shooting device, and sending the one or more control parameters and the shooting range to a gimbal, so that the gimbal determines shooting angles according to the one or more control parameters and the shooting range and performs image capture according to the shooting angles.

Also in accordance with the disclosure, there is provided a gimbal including a memory storing program codes and a processor configured to call the program codes to obtain one or more control parameters and a shooting range, obtain an image amount according to the one or more control parameters and the shooting range, determine shooting angles according to the shooting range and the image amount, and perform image capture according to the shooting angle.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic diagram of an image capture method according to an embodiment of the disclosure.

FIG. 2 is a schematic diagram of another image capture method according to an embodiment of the disclosure.

FIGS. 3A-3C are schematic diagrams of application scenarios of an embodiment.

FIG. 3D is a schematic diagram of another image capture method according to an embodiment of the disclosure.

FIGS. 4A-4I are schematic diagrams of a control interface.

FIG. 5A is a block diagram of a gimbal according to an embodiment.

FIG. 5B is a block diagram of a control device according to an embodiment.

### DETAILED DESCRIPTION OF THE EMBODIMENTS

The technical solutions in the embodiments of the present disclosure will be described in more detail with reference to the accompanying drawings in the embodiments of the present disclosure. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure. In addition, if there is no conflict, the following embodiments and the features in the embodiments can be combined with each other.

The terminology used in this disclosure is for the purpose of describing particular embodiments only and is not intended to limit the disclosure. As used in this disclosure and the appended claims, the singular forms “a” and “the” are intended to include the plural forms as well, unless the context clearly indicates otherwise. The term “and/or” as used herein refers to and includes any or all possible combinations of one or more of the associated listed items.

Although the terms first, second, third, etc. may be used to describe various information in the present disclosure, the information should not be limited to these terms. These terms are used to distinguish the same type of information from each other. For example, without deviating from the scope of the present disclosure, the first information may be referred to as second information, and similarly, the second information may be referred to as first information. In addition, depending on the context, the term “if” can be interpreted as “when,” or “while,” or “in response to a determination.”

An image capture method is provided according to an embodiment of the present disclosure and the image capture method can be applied to a gimbal. FIG. 1 is a schematic flow chart of the image capture method.

As shown in FIG. 1, at 101, one or more control parameters and a shooting range are obtained.

Obtaining the control parameter and the shooting range may include, but is not limited to, obtaining the control parameter and the shooting range from a control device, or obtaining part or all of the control parameters from a shooting device and obtaining the shooting range from the control device. Further, the control parameter may include, but is not limited to, one or any combination of a sensor type of the shooting device, a focal length, an overlap ratio, and a delay time. The shooting range may include, but is not limited to, a start shooting angle and/or a finish shooting angle.

At 102, an image amount is obtained according to the one or more control parameters and the shooting range.

In this disclosure, an image can include a plurality of frames (sub-images) forming the image, and the image amount can refer to, e.g., a number of frames in the image. Obtaining the image amount according to the control parameter and the shooting range may include, but is not limited to, determining an occupancy size of each frame of the image according to the sensor type, the focal length, and the overlap ratio, determining a total size of the image according to the shooting range, and obtaining the image amount according to the occupancy size of each frame and the total size of the image. The occupancy size of a frame is also referred to as a “frame occupancy size” and the total size of the image is also referred to as a “total image size.”

Further, determining the occupancy size of each frame of the image according to the sensor type, the focal length, and the overlap ratio may include, but is not limited to, determining an actual size of each frame of the image according to the sensor type and the focal length, and determining the occupancy size of each frame of the image according to the actual size of each frame of the image and the overlap ratio.

At 103, shooting angles are determined according to the shooting range and the image amount.

In some embodiments, determining the shooting angles according to the shooting range and the image amount may include, but is not limited to, dividing the angle between the start shooting angle and the finish shooting angle into the image amount of shooting angles if the shooting range includes the start shooting angle and the finish shooting angle. In this disclosure, the image amount of shooting angles means the number of shooting angles is the same as the image amount.

Further, dividing the angle between the start shooting angle and the finish shooting angle into the image amount of shooting angles may include determining an angle difference between the finish shooting angle and the start shooting angle, obtaining an average angle according to the angle difference and the image amount, and obtaining the image amount of shooting angles according to the average angle. For example, if the finish shooting angle is 100 degrees, the start shooting angle is 0 degrees, and the image amount is 100, then the angle difference is 100 degrees and the average angle is 1 degree (that is, the angle difference (100 degrees) divided by the image amount (100)). Therefore, the first shooting angle is 1 degree (the start shooting angle+the average angle), the second shooting angle is 2 degrees (the first shooting angle+the average angle), and the third shooting angle is 3 degrees (the second shooting angle+the average angle), and so on, the 100th shooting angle is 100 degrees.

At 104, an image capture (also referred to as “image acquisition”) is performed according to the shooting angles.

Performing the image capture according to the shooting angles may include moving the gimbal to the shooting angles and sending a shooting command to the shooting device. The shooting command is used to control the shooting device to perform image capture at a shooting angle. Further, moving the gimbal to the shooting angles may include, if the control parameter also includes the delay time, moving the gimbal to a shooting angle after the gimbal stays at a previous shooting angle for a period equaling the delay time. In addition, moving the gimbal to the shooting angle may include sequentially moving the gimbal to each of all the shooting angles according to a pause strategy.

In the above embodiments, the gimbal may be connected to the shooting device through a control line, and the gimbal may send the shooting command to the shooting device through the control line. The gimbal can also be connected to the shooting device in another manner, which is not limited here. In the examples described below, the gimbal is connected to the shooting device through the control line.

In some embodiments, the shooting angle may include the attitude information of the gimbal and the attitude information may include one or any combination of yaw attitude, roll attitude, and pitch attitude.

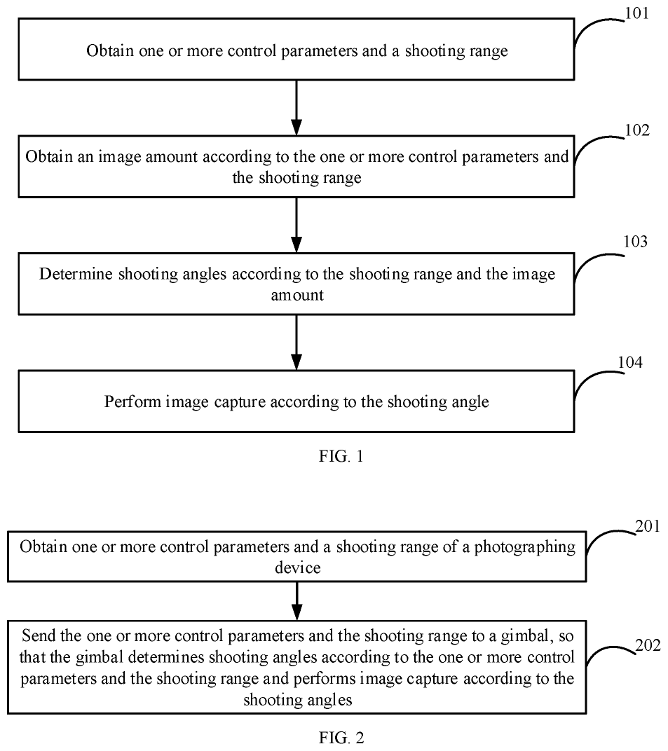

An image capture method is provided according to an embodiment of the present disclosure and the method can be applied to a control device. FIG. 2 is a schematic flow chart of the image capture method.

As shown in FIG. 2, at 201, one or more control parameters and a shooting range are obtained.

Obtaining the control parameter of the shooting device may include, but is not limited to, displaying a control interface to a user and receiving control parameters input by the user on the control interface, and/or obtaining part or all of the control parameters of the shooting device from the shooting device. Further, the control parameter may include, but is not limited to, one or any combination of a sensor type of the shooting device, a focal length, an overlap ratio, and a delay time.

In some embodiments, obtaining the shooting range of the shooting device may include, but is not limited to, displaying a control interface to a user and receiving the shooting range input by the user on the control interface, and/or obtaining an actual shooting angle of the gimbal and determining the shooting range according to the actual shooting angle of the gimbal.

In some embodiments, obtaining the actual shooting angle of the gimbal may include, but is not limited to, the control device sending a request for obtaining the shooting angle to the gimbal, receiving a shooting angle command returned by the gimbal in response to the request, and obtaining the actual shooting angle of the gimbal from the shooting angle command.

In some embodiments, obtaining the actual shooting angle of the gimbal may include, but is not limited to, the control device displaying a control interface, which includes a gimbal moving button, to a user, obtaining the actual shooting angle of the gimbal if an operation command for the gimbal moving button is received, and then setting the shooting range. In some other embodiments, the control device displays a control interface, which includes a virtual joystick for controlling the shooting angle of the gimbal, to a user, the actual shooting angle of the gimbal can be obtained if an operation command for the virtual joystick is received, and then the shooting range is set.

At 202, the one or more control parameters and the shooting range are sent to the gimbal, so that the gimbal determines the shooting angles according to the control parameter and the shooting range and performs an image capture according to the shooting angles.

In some embodiments, after the control device obtains the control parameter and the shooting range of the shooting device, the image amount can be obtained according to the control parameter and the shooting range, and the shooting angles are determined according to the shooting range and the image amount. The control parameter may include a sensor type, a focal length, and an overlap ratio. Obtaining the image amount according to the control parameter and the shooting range may include, but is not limited to, determining an occupancy size of each frame of the image according to the sensor type, the focal length, and the overlap ratio, determining a total size of the image according to the shooting range, and obtaining the image amount according to the occupancy size of each frame and the total size of the image.

Further, determining the occupancy size of each frame of the image according to the sensor type, the focal length, and the overlap ratio may include, but is not limited to, determining an actual size of each frame of the image according to the sensor type and the focal length, and determining the occupancy size of each frame of the image according to the actual size of each frame of the image and the overlap ratio.

In some embodiments, determining the shooting angles according to the shooting range and the image amount may include, but is not limited to, dividing the angle between the start shooting angle and the finish shooting angle into the image amount of shooting angles if the shooting range includes the start shooting angle and the finish shooting angle. Further, dividing the angle between the start shooting angle and the finish shooting angle into the image amount of shooting angles may include determining an angle difference between the finish shooting angle and the start shooting angle, obtaining an average angle according to the angle difference and the image amount, and obtaining the image amount of shooting angles according to the average angle.

In some embodiments, after the image amount is obtained according to the control parameter and the shooting range, the control device may display a control interface to a user and the control interface may include the image amount.

In some embodiments, after the shooting angle is determined according to the shooting range and the image amount, the control device may display a control interface to the user, and the control interface may include a preview button. If a preview command for the preview button is received, the shooting angle of the gimbal is controlled according to the shooting angle.

In some embodiments, after the shooting angle is determined according to the shooting range and the image amount, if an adjustment command for the shooting range is received, an adjusted shooting range is obtained, and the above determined shooting range is adjusted using the adjusted shooting range.

Obtaining the adjusted shooting range may include, but is not limited to, displaying a control interface to a user and receiving the adjusted shooting range input by the user on the control interface, and/or obtaining the actual shooting angle of the gimbal and determining the adjusted shooting range according to the actual shooting angle of the gimbal.

In some embodiments, obtaining the actual shooting angle of the gimbal may include, but is not limited to, the control device sending a request for obtaining the shooting angle to the gimbal, and receiving the shooting angle command returned by the gimbal in response to the request, and then obtaining the actual shooting angle of the gimbal from the shooting angle command.

In some embodiments, obtaining the actual shooting angle of the gimbal may include, but is not limited to, the control device displaying a control interface, which includes a gimbal moving button, to a user, obtaining the actual shooting angle of the gimbal if an operation command for the gimbal moving button is received, and then setting the shooting range. In some other embodiments, the control device displays a control interface, which includes a virtual joystick for controlling the shooting angle of the gimbal, to a user, the actual shooting angle of the gimbal can be obtained if an operation command for the virtual joystick is received, and then the shooting range is set.

In some embodiments, the control device may display a control interface to the user, the control interface includes a real-time position of the shooting device, so that the user can intuitively view the real-time position of the shooting device.

In some embodiments, the shooting angle may include the attitude information of the gimbal and the attitude information may include one or any combination of yaw attitude, roll attitude, and pitch attitude.

Based on the above technical solution, in the embodiments of the present disclosure, the gimbal can obtain the control parameter and the shooting range, obtain the image amount according to the control parameter and the shooting range, determine the shooting angles according to the shooting range and the image amount, and then perform image capture according to the shooting angle. That is, the gimbal can determine the image amount of shooting angles, and perform the image capture at each shooting angle. Therefore, an image beyond the field of view of the lens can be captured, and a large-field-of-view shooting can be performed easily and automatically. As a result, these images are combined into a huge photo to form a shocking effect, which is used for large-scale landscape shooting.

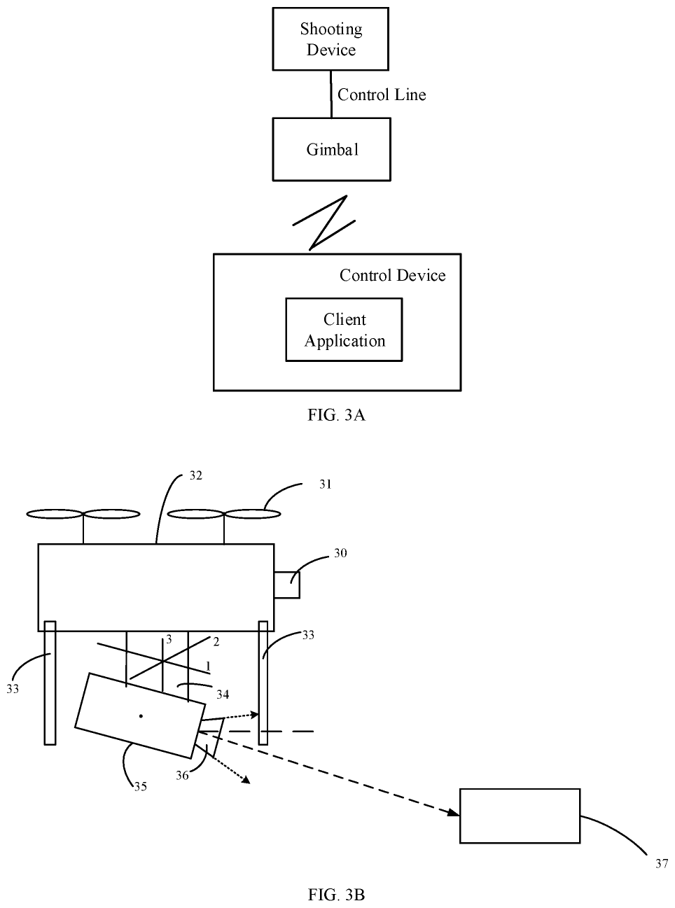

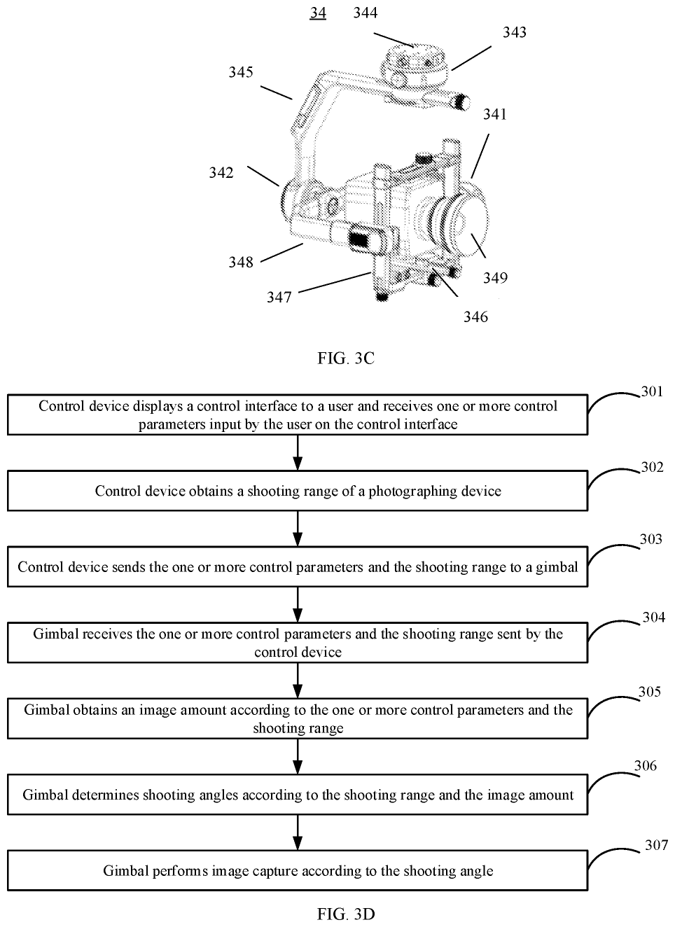

FIG. 3A is a schematic diagram of one application scenario, which includes a gimbal, a control device, and a shooting device. The control device is provided with an application (APP) capable of communicating with the gimbal.

The control device can communicate with the gimbal, and the connection between them can be a wired connection or a wireless connection, which is not limited here. The wireless connection (such as WiFi, OcuSync, Lightbridge, Auxiliary, etc.) is shown in FIG. 3A as an example. In addition, the gimbal can communicate with the photographing equipment, and the connection between them can be a wired connection or a wireless connection, which is not limited here. For example, as shown in FIG. 3A, the gimbal is connected to the shooting device through a control line (such as a camera control line). The gimbal can control the shooting device through the control line, such as sending a control signal through the control line to realize controlling and adjusting a shutter and shooting parameters of the shooting device, and adjusting the shooting angle of the shooting device automatically.

In some embodiments, the gimbal may be a handheld gimbal or another type of gimbal, which is not limited. In addition, the gimbal may be an independent gimbal, that is, a gimbal used for carrying shooting device, which is not provided at an unmanned aerial vehicle (UAV). The gimbal may be a gimbal provided at the UAV, which is no limited here.

FIG. 3B is a schematic diagram showing a gimbal provided at a UAV. 30 denotes a nose of the UAV, 31 denotes a propeller of the UAV, 32 denotes a body of the UAV, 33 denotes landing gear of the UAV, 34 denotes the gimbal provided at the UAV, and 35 denotes a shooting device carried by the gimbal 34. The shooting device 35 is connected to the body 32 of the UAV through the gimbal 34. 36 denotes a shooting lens of the shooting device, and 37 denotes a target object.

In the above embodiments, the gimbal may be a three-axis (such as roll axis, pitch axis, yaw axis, etc.) gimbal, that is, the gimbal 34 rotates around the roll axis, the pitch axis, and the yaw axis of the gimbal. As shown in FIG. 3B, 1 denotes the roll axis of the gimbal, 2 denotes the pitch axis of the gimbal, and 3 denotes the yaw axis of the gimbal. When the gimbal rotates around the roll axis, the roll attitude of the gimbal changes. When the gimbal rotates around the pitch axis, the pitch attitude of the gimbal changes. When the gimbal rotates around the yaw axis, the yaw attitude of the gimbal changes. Moreover, when the gimbal rotates around one or more of the roll axis, pitch axis, and yaw axis, the shooting device 35 rotates following the rotation of the gimbal 34, so that the shooting device 35 can shoot images of the target object 37 from different shooting directions and shooting angles. In one example, the gimbal can be controlled to rotate around one or more of the roll axis, pitch axis, and yaw axis.

Further, FIG. 3C is a structural diagram of a three-axis gimbal (labeled as gimbal 34). The gimbal 34 mainly includes a pitch-axis motor 341, a roll-axis motor 342, a yaw-axis motor 343, a gimbal base 344, a yaw-axis arm 345, a fixing mechanism of the shooting device 346, a pitch-axis arm 347, a roll-axis arm 348, a shooting device 349. The shooting device 349 can include an inertial measurement unit (IMU). In some embodiments, the IMU can be arranged at the fixing mechanism 346. A position of the IMU is not limited herein. The roll-axis arm 348 is used to support the pitch-axis arm 347 and the pitch-axis motor 341, the yaw-axis arm 345 is used to support the yaw-axis motor 343 and the roll-axis motor 342, and the pitch-axis arm 347 is used to support the shooting device 349. Each of the pitch-axis motor 341, the roll-axis motor 342, and the yaw-axis motor 343 (the three motors can be collectively referred to as drive motors), an angle sensor and a circuit board can be mounted. The angle sensors can be electrically connected to the circuit board. When the drive motor rotates, a rotation angle of the drive motor can be measured through the angle sensor mounted at the drive motor. The angle sensor can be one or more of a potentiometer, a Hall sensor, and an encoder.

In some embodiments, the gimbal mainly uses the inertial measurement unit as a feedback element and uses the drive motors of each axis (yaw axis, pitch axis, roll axis) of the gimbal as output elements to form a closed-loop control system to control a gimbal attitude. In the process of controlling the gimbal attitude, the control value is the gimbal attitude. For a given target attitude, a current attitude of the gimbal is corrected to the target attitude through the feedback control, so that the gimbal approaches the target attitude from the current attitude, and finally reaches the target attitude.

In some embodiments, the control device may include, but is not limited to, a remote control, a smart phone/mobile phone, a tablet computer, a personal digital assistant (PDA), a laptop computer, a desktop computer, a media content player, a video game console/system, a virtual reality system, an augmented reality system, a wearable device (such as, a watch, a pair of glasses, a pair of gloves, a headwear (such as a hat, a helmet, a virtual reality headset, an augmented reality headset, a head mounted device (HMD), a headband)), a pendant, an armband, a leg ring, a pair of shoes, a vest), a gesture recognition device, a microphone, or any electronic device that can provide or render image data.

FIG. 3D is a schematic flowchart of an image capture method that can be implemented in the above application scenario.

As shown in FIG. 3D, at 301, a control device displays a control interface to a user and receives one or more control parameters input by the user on the control interface. The control parameter may include, but is not limited to, one or any combination of a sensor type, a focal length, an overlap ratio, a delay time, etc. of a shooting device, which is not limited.

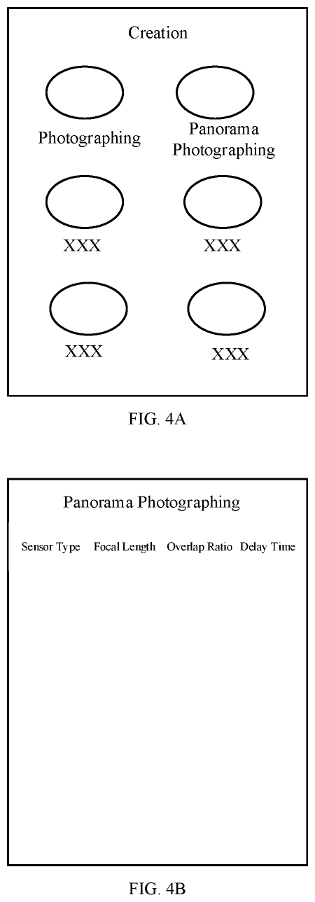

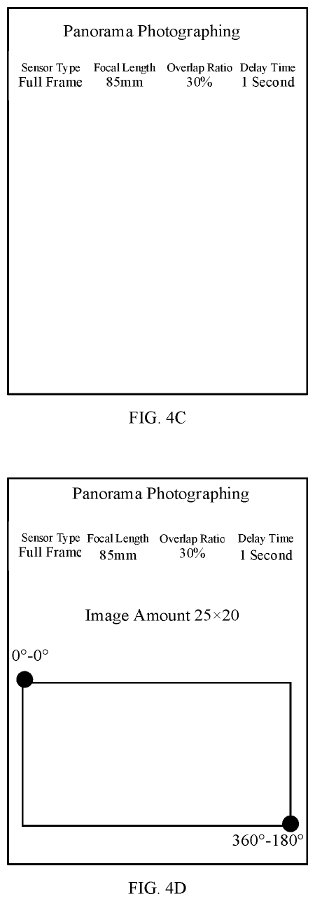

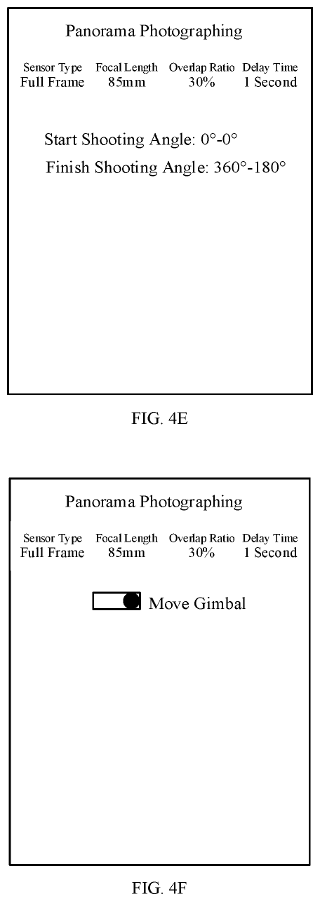

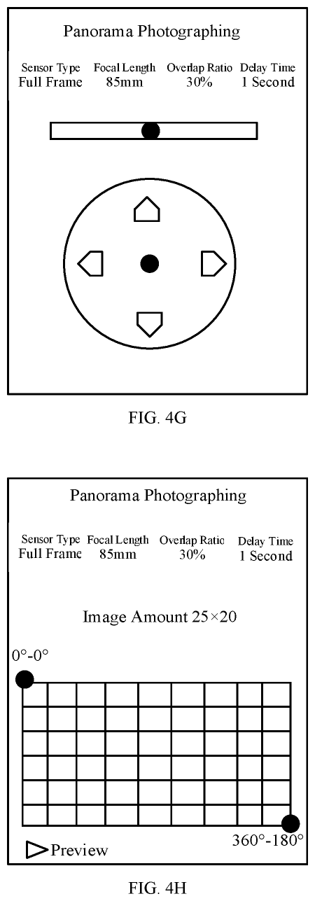

For example, the control device may display a control interface shown in FIG. 4A to the user. The control interface includes an option of panorama photographing. When the user clicks on the panorama photographing, the control device receives an operation command for the panorama photographing and displays a control interface shown in FIG. 4B to the user. The user can input the sensor type, the focal length, the overlap ratio, the delay time and other control parameters on the control interface, as shown in FIG. 4C. Therefore, the control device can obtain the control parameters such as the sensor type, the focal length, the overlap ratio, and the delay time, etc.

For example, as shown in FIG. 4C, the sensor type is full frame, the focal length is 85 mm, the overlap ratio is 30%, and the delay time is 1 second. In some practical applications, the sensor type, the focal length, the overlap ratio, and the delay time may all be other values, which is not limited here. The following description takes FIG. 4C as an example.

In practical applications, the control device can receive the control parameters input by the user on the control interface, or can obtain all or part of the control parameters of the shooting device from the shooting device. For example, the control device can obtain control parameters such as the sensor type and the focal length from the shooting device and receive control parameters such as the overlap ratio and the delay time input by the user on the control interface, the process of which is not repeated. The control device can also use other methods to obtain the control parameters of the shooting device, which is not limited.

At 302, the control device obtains a shooting range of the shooting device. The shooting range may include a start shooting angle and a finish shooting angle. Both the start shooting angle and the finish shooting angle may include the attitude information of a gimbal, for example, the yaw attitude, the roll attitude, the pitch attitude, etc. of the gimbal.

As shown in FIG. 4D, the rectangular frame represents the shooting range, the upper left corner is the start shooting angle, and the lower right corner is the finish shooting angle. For the convenience of description, the start shooting angle and the finish shooting angle both include the roll attitude and the pitch attitude. The roll attitude of the start shooting angle is 0°, and the pitch attitude of the start shooting angle is 0°, and the start shooting angle can be denoted as 0°-0°. The roll attitude of the finish shooting angle is 360°, and the pitch attitude of the finish shooting angle is 180°, and the finish shooting angle can be denoted as 360°-180°. The above is only an example of the start shooting angle and the finish shooting angle, which is not limited here. FIG. 4D is used as an example in the following description.

In some embodiments, the control device obtaining the shooting range may include, but is not limited to, displaying a control interface to the user and receiving the shooting range input by the user on the control interface.

For example, the control device displays the control interface shown in FIG. 4E to the user, and the user can input the start shooting angle and the finish shooting angle on the control interface (for example, inputting 0°-0° as the start shooting angle, and 360°-180° as the finish shooting angle), so that the control device can obtain the starting shooting angle and the finish shooting angle. The range from the start shooting angle and the finish shooting angles are the shooting range. Based on the start shooting angle and the finish shooting angles, the control interface shown as FIG. 4D can be displayed.

In some embodiments, the control device obtaining the shooting range may include, but is not limited to, displaying a control interface, which includes a gimbal moving button, to a user. If the user clicks the gimbal moving button, the control device can receive an operation command for the gimbal moving button, obtain an actual shooting angle of the gimbal, and determine the shooting range according to the actual shooting angle of the gimbal.

After the user clicks the gimbal moving button, the gimbal can be moved directly by hand or in another manner to adjust the gimbal attitude (such as the yaw attitude, the roll attitude, the pitch attitude, etc.), so that the gimbal can quickly rotate to a target shooting angle. Moreover, when the control device obtains the actual shooting angle of the gimbal, what is obtained is the target shooting angle, so that the control device obtains the shooting angle after the gimbal is moved, which is used to determine the shooting range.

For example, for the start shooting angle, the control device displays a control interface shown in FIG. 4F to the user, and the control interface includes a gimbal moving button. The user clicks on the gimbal moving button and adjusts the actual shooting angle of the gimbal by moving the gimbal (that is, actually operating the gimbal). For example, if the user wants the start shooting angle to be 0°-0°, the gimbal is moved to 0°-0°. The control device obtains the actual shooting angle of the gimbal after receiving the operation command for the gimbal moving button. Since the gimbal is moved to 0°-0°, the actual shooting angle of the gimbal is 0°-0°, that is, the start shooting angle is 0°-0°.

For the finish shooting angle, the user moves the gimbal to 360°-180°, and the control device obtains the finish shooting angle as 360°-180°. For detailed description of this process, reference can be made to the process for the start shooting angle, which is not repeated here.

Through the above method, the control device can obtain the start shooting angle and the finish shooting angle, that is, the shooting range, and display the control interface shown in FIG. 4D based on the start shooting angle and the finish shooting angle.

In some embodiments, the control device obtaining the shooting range may include, but is not limited to, displaying a control interface, which includes a virtual joystick for controlling the shooting angle of the gimbal, to a user. If the user operates the virtual joystick, the control device can receive an operation command for the virtual joystick, obtain an actual shooting angle of the gimbal, and determine the shooting range according to the actual shooting angle of the gimbal.

For example, for the start shooting angle, the control device displays a control interface shown in FIG. 4G to the user, and the control interface includes a virtual joystick. The user can adjust the actual shooting angle of the gimbal by operating the virtual joystick. For example, the roll attitude of the gimbal can be controlled when the user slides left and right inside a circle, the pitch attitude of the gimbal can be controlled when the user slides up and down inside the circle, and the yaw attitude of the gimbal can be controlled when the user slides left and right in a rectangle. Based on this, if the user wants the start shooting angle to be 0° of roll attitude −0° of pitch attitude, the user can slide left and right inside the circle to control the roll attitude of the gimbal to 0°. In this way, the roll attitude of the gimbal is adjusted to 0°. In addition, the user can slide up and down inside the circle to control the pitch attitude of the gimbal to 0°, so that the pitch attitude of the gimbal is adjusted to 0°. When the user operates the virtual joystick, the control device can also receive an operation command for the virtual joystick. After the operation command is received, the actual shooting angle of the gimbal can be obtained. Since the gimbal is adjusted to 0°-0° by the virtual joystick, the actual shooting angle of the gimbal is 0°-0°, that is, the start shooting angle is 0°-0°.

For the realization process for the finish shooting angle, reference can be made to the process for the start shooting angle. For example, the user slides left and right inside the circle to control the roll attitude of the gimbal to 360°, so that the roll attitude of the gimbal is adjusted to 360°. The user slides up and down inside the circle to control the pitch attitude of the gimbal to 180°, so that the pitch attitude of the gimbal is adjusted to 180°. In this way, the control device obtains the finish shooting angle as 360°-180°.

Through the above method, the control device can obtain the start shooting angle and the finish shooting angle, that is, the shooting range, and display the control interface shown in FIG. 4D based on the start shooting angle and the finish shooting angle.

In the above embodiments, in order to obtain the actual shooting angle of the gimbal, the control device can send a request for obtaining the shooting angle to the gimbal. After receiving the request, the gimbal may obtain a current actual shooting angle of the gimbal and send a shooting angle command to the control device. The shooting angle command may carry the actual shooting angle of the gimbal. In this way, the control device may obtain the actual shooting angle of the gimbal from the shooting angle command, such as the start shooting angle or the finish shooting angle.

The above embodiments are just a few examples of obtaining the actual shooting angle of the gimbal, and there are no restrictions on the obtaining method. For example, except for the method of moving the gimbal and the method of controlling the gimbal with the virtual joystick, a real joystick can be used to control the shooting angle of the gimbal. In this way, the control device can also obtain the actual shooting angle of the gimbal. The implementation process is similar and is not repeated here.

Referring again to FIG. 3D, at 303, the control device sends the one or more control parameters and the shooting range to the gimbal.

At 304, the gimbal receives the one or more control parameters (such as the sensor type, the focal length, the overlap ratio, the delay time) and the shooting range (such as the start shooting angle and the finish shooting angle) sent by the control device.

In some embodiments, the gimbal may obtain the control parameter and the shooting range from the control device. In some other embodiments, the gimbal may obtain some or all of the control parameters from the shooting device (such as obtaining the control parameters such as the sensor type and the focal length from the shooting device), obtain the shooting range from the control device, and obtain some or all of the control parameters from the control device (such as obtaining control parameters such as the overlap ratio and the delay time from the control device). In some embodiments, for example, the gimbal obtains the control parameters and the shooting range from the control device.

At 305, the gimbal obtains an image amount according to the one or more control parameters and the shooting range. The gimbal obtaining the image amount according to the control parameters and the shooting range may include the gimbal determining an actual size of each frame of image according to the sensor type and the focal length, determining an occupancy size of each frame of image according to the actual size of the image and the overlap ratio, determining a total size of the image according to the shooting range, and obtaining the image amount according to the occupancy size of each frame of image and the total size of the image.

The sensor type is the sensor type of the shooting device. For example, the sensor type can include, but is not limited to, a full frame or a half frame (also called APS-C frame). The full frame or half frame can refer to a size of an electronic photosensitive element (such as CMOS or CCD). For example, the size of a full-frame electronic photosensitive element can be 24 mm×36 mm, and the size of a half-frame electronic photosensitive element can be 23.7 mm×15.6 mm. The above sizes are only examples of the full frame and the half frame, and there is no restriction on this. After the sensor type is determined, the gimbal can determine the size of the electronic photosensitive element according to the sensor type.

The focal length is the focal length of the lens of the shooting device, is a measure of the concentration or divergence of light in an optical system, and can refer to a distance from a center of the lens to the electronic photosensitive element when a parallel light ray is incident.

The gimbal can determine the size of the electronic photosensitive element according to the sensor type, and determine the distance from the center of the lens to the electronic photosensitive element according to the focal length. Further, based on the size of the electronic photosensitive element and the distance from the center of the lens to the electronic photosensitive element, the actual size of each frame of image can be determined, that is, how large each frame of image can correspond to. There is no restriction on this determination method, and it can be determined in a traditional manner.

In some embodiments, the gimbal determining the occupancy size of each frame of the image according to the actual size of the image and the overlap ratio may include, but is not limited to, the gimbal determining the occupancy size of each frame as the actual size of the image×(1-overlap ratio). For example, when the overlap ratio is 30%, the occupancy size of each frame is the actual size of the image×70%.

The overlap ratio can indicate the degree of overlap between frames. For example, the first frame of image and the second frame of image have an overlap area of 30%, the second frame of image and the third frame of image have an overlap area of 30%, and so on. Based on this, in each frame of image, 30% of the area can be overlapped with the previous frame, and the remaining 70% of the area is different from the previous frame. In this way, it can be determined that the occupancy size of each frame of image is the actual size of the image×70%, which means that 70% of the actual size of the image can be the occupancy size of the image.

In some embodiments, determining the total size of the image by the gimbal according to the shooting range may include determining the total size of the image by the gimbal according to the start shooting angle and the finish shooting angle. For example, when the start shooting angle is 0°-0°, and the finish shooting angle is 360°-180°, the roll attitude of the gimbal is from 0° to 360°, and the pitch attitude of the gimbal is from 0° to 180°. In the rotation process, the shooting range of the gimbal is the total size of the image. The rectangular frame shown in FIG. 4D can represent the total size of the image.

In some embodiments, the gimbal obtaining the image amount according to the occupancy size of each frame of image and the total size of the image includes, but is not limited to, determining a first amount while the roll attitude is rotated from the start shooting angle to the finish shooting angle by using the occupancy size of each frame of image and the total size of the image, determining a second amount while the pitch attitude is rotated from the start shooting angle to the finish shooting angle by using the occupancy size of each frame of image and the total size of the image, and then determining that the image amount is the first amount×the second amount.

For example, if the occupancy size of each frame of image is 4×3 and the total size of the image is 100×60, the first amount, when the roll attitude is rotated from 0° to 360°, is determined to be 25 (100/4), and the second amount, when the pitch attitude is rotated from 0° to 180°, is determined to be 20 (60/3). Therefore, the image amount is 500 (25×20).

At 306, the gimbal determines shooting angles according to the shooting range and the image amount.

In some embodiments, determining shooting angles of the gimbal according to the shooting range and the image amount may include dividing an angle between the start shooting angle and the finish shooting angle into the image amount of shooting angles. In some embodiments, an angle difference between the finish shooting angle and the start shooting angle can be determined, an average angle is obtained according to the angle difference and the image amount, and the image amount of shooting angles are obtained according to the average angle.

For example, the angle between the start shooting angle of 0°-0° and the finish shooting angle of 360°-180° can be divided into 500 shooting angles on average. In another word, the first shooting angle is 0°-0°, the second shooting angle is 14.4°-0°, the third shooting angle is 28.8°-0°, and so on, the 25th shooting angle is 360°-0°. The 26th shooting angle is 0°-9°, the 27th shooting angle is 14.4°-9°, and so on, the 50th shooting angle is 360°-9°. The 51st shooting angle is 0°-18°, and so on. The 500th shooting angle is 360°-180°.

Since the gimbal rotates from 0° to 360° in the roll attitude, the angle difference is 360°, and since the image amount is 25, the average angle of 14.4° can be obtained through dividing 360° by 25. In the roll attitude direction, there are 25 shooting angles, and the angle difference between two adjacent shooting angles is 14.4°. That is, the first shooting angle of the roll attitude direction is 0°, the second shooting angle is 14.4°, the third shooting angle is 28.8°, and so on, the 25th shooting angle is 360 degrees.

Further, since the gimbal rotates from 0° to 180° in the pitch attitude, the angle difference is 180°, and since the image amount is 20, the average angle of 9° can be obtained through dividing 180° by 20. In the pitch attitude direction, there are 20 shooting angles, and the angle difference between two adjacent shooting angles is 9°. That is, the first shooting angle of the pitch attitude direction is 0°, the second shooting angle is 9°, the third shooting angle is 18°, and so on, the 20th shooting angle is 180°.

At 307, the gimbal performs an image capture according to the shooting angles.

The gimbal performing image capture according to the shooting angles may include sequentially moving the gimbal to each of all the shooting angles according to a pause strategy. After the gimbal stays at each shooting angle for the delay time (such as 1 second, etc.), the gimbal is moved to the next shooting angle of the shooting angle, and a shooting command is sent to the shooting device (for example, the shooting command can be sent to the shooting device through a control line). After receiving the shooting command, the shooting device can capture one or more frames of image.

For example, at the first shooting angle of 0°-0°, the gimbal sends a shooting command to the shooting device and stays for 1 second, and the shooting device captures a frame of image with the shooting angle of 0°-0°. After staying for 1 second, the gimbal moves to the second shooting angle of 14.4°-0°, sends a shooting command to the shooting device, and stays for 1 second. The shooting device captures a frame of image with the shooting angle of 14.4°-0°. After staying for 1 second, the gimbal moves to the third shooting angle of 28.8°-0°, and so on, until the gimbal moves to the 500th shooting angle of 360°-180°, sends a shooting command to the shooting device, and stays for 1 second, and the shooting device captures a frame of image with the shooting angle of 360°-180°. At this point, the image capture process is completed, and the shooting device can obtain multiple frames of image.

After multiple frames of image are obtained, the multiple frames of image can be used to synthesize a huge image, thereby completing the panorama photographing. The method of synthesizing the huge image with multiple frames of image is not repeated in this disclosure.

In the above-described embodiments, after the process of 302 and before the process of 303, the control device may obtain the image amount according to the control parameters and the shooting range, and determine the shooting angles according to the shooting range and the image amount. The process of 305 can be referred to for the method for the control device to obtain the image amount, except for that the execution subject is changed from the gimbal to the control device, and the method is not repeated here. The process of 306 can be referred to for he method for the control device to determine the shooting angles, except for that the execution subject is changed from the gimbal to the control device, and the method is not repeated here.

In some embodiments, after the shooting range is obtained at 302, the shooting range can be adjusted, that is, an adjusted shooting range is obtained, and the adjusted shooting range is used to adjust the shooting range obtained at 302. As follows, the scenarios where the shooting range needs to be adjusted are explained.

In some embodiments, after obtaining the image amount, the control device may display a control interface to a user, and the control interface may include the image amount. In this way, the user gets to know the image amount. If the image amount meets the user's needs, the user does not adjust the shooting range. If the image amount does not meet the user's needs, the user can adjust the shooting range, that is, an adjustment of the shooting range is triggered.

In some embodiments, after obtaining the shooting angle (for example, 500 shooting angles), the control device may display a control interface to the user, and the control interface includes a preview button, such as shown in FIG. 4H. If the user clicks the preview button, the control device can receive a preview command for the preview button, and control the shooting angle of the gimbal according to all shooting angles. For example, first the gimbal is controlled to move to a shooting angle of 0°-0°, then the gimbal is controlled to move to a shooting angle of 14.4°-0°, and then the gimbal is controlled to move to a shooting angle of 28.8°-0°, and so on, until the gimbal is controlled to move to a shooting angle of 360°-180°, then the preview process ends. In some embodiments, after a user's command of stopping the preview is received, the preview process ends.

During the preview process, the user can view the shooting angle of the gimbal in real time, view the light changes at different shooting angles, and view other factors that affect the shooting effect. In this way, if the shooting angle is found to meet the user's needs, the user does not adjust the shooting range. If the shooting angle is found to not meet the user's needs, the user can adjust the shooting range, that is, triggering the adjustment of the shooting range.

Based on the above embodiments, the adjustment of the shooting range can be triggered. In the process of adjusting the shooting range, the control device can display a control interface to the user. The control interface can include an adjustment button for the shooting range. If the user clicks the adjustment button, the control device can receive an adjustment command for the shooting range and obtain the adjusted shooting range. Then, the adjusted shooting range can be used to adjust the shooting range obtained at 302. Therefore, at 303, what the control device sends to the gimbal is the adjusted shooting range.

The control device obtaining the adjusted shooting range may include, but is not limited to, displaying the control interface to the user, and receiving the adjusted shooting range input by the user on the control interface, and/or displaying a control interface, which includes a gimbal moving button, to a user. If the user clicks the gimbal moving button, the control device can receive an operation command for the gimbal moving button, obtain an actual shooting angle of the gimbal, and determine the shooting range according to the actual shooting angle of the gimbal. After the user clicks the gimbal moving button, the gimbal can be moved directly by hand or in other ways to adjust the gimbal, so that the gimbal can quickly rotate to a target shooting angle. When the control device obtains the actual shooting angle of the gimbal, what obtained is the target shooting angle, so that the control device obtains the shooting angle after the gimbal is moved, which is used to determine the shooting range. In some embodiments, the control device obtaining the shooting range may include, but is not limited to, displaying a control interface, which includes a virtual joystick for controlling the shooting angle of the gimbal, to a user. If the user operates the virtual joystick, the control device can receive an operation command for the virtual joystick, obtain an actual shooting angle of the gimbal, and determine the shooting range according to the actual shooting range of the gimbal. The description of the process of 302 can be referred to for details of the above embodiments, which is not repeated here.

The above embodiments are just a few examples of obtaining the actual shooting angle of the gimbal, and there are no restrictions on the obtaining method. For example, except for the method of moving the gimbal and the method of controlling the gimbal with the virtual joystick, a real joystick can be used to control the shooting angle of the gimbal. In this way, the control device can also obtain the actual shooting angle of the gimbal. The implementation process is similar and is not repeated here.

In some embodiments, the control device may display a control interface to the user, the control interface includes a real-time position of the shooting device, as shown in FIG. 4I, so that the user can intuitively view the real-time position of the shooting device. For example, during the preview process, the control interface can also display the shooting angle of the gimbal in real time. When the image capture is performed according to the shooting angle of the gimbal, the control interface can also display the shooting angle of the gimbal in real time.

Based on the above technical solution, in the embodiments of the present disclosure, the gimbal can obtain the control parameters and the shooting range, obtain the image amount according to the control parameters and the shooting range, determine the shooting angles according to the shooting range and the image amount, and then, perform image capture according to the shooting angles. That is, the gimbal can determine the image amount of shooting angles, and perform image capture at each shooting angle. Therefore, an image beyond the field of view of the lens can be captured, and a large-field-of-view shooting can be performed easily and automatically. As a result, these images are combined into a huge photo to form a shocking effect, which is used for large-scale landscape shooting.

In the above embodiments, a large-field-of-view shooting can be performed automatically, quickly, steadily and clearly to obtain images beyond the field of view of the shooting device, and the panorama photographing can be completed by combining with a post-composition. Moreover, with the control function of the gimbal attitude, the image can be maintained horizontal, and the entire shooting can be completed automatically. The operation is simple, and the shooting can be completed quickly and automatically. The shooting angle can be adjusted quickly and finely. The shooting angle can be previewed quickly with the preview function and the changes in light can be viewed from different angles.

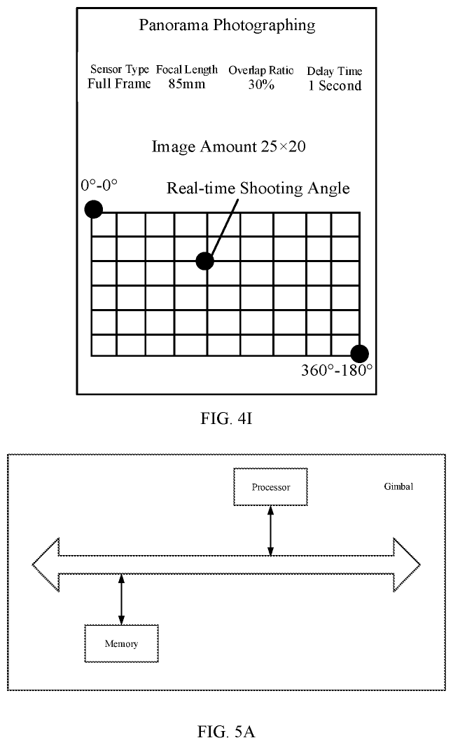

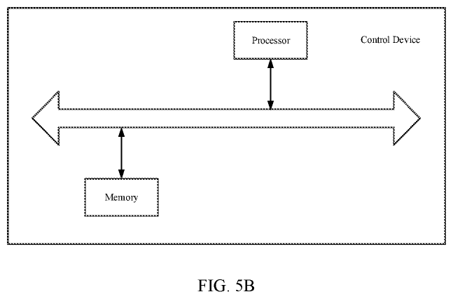

A gimbal is provided according to an embodiment of the present disclosure. The gimbal includes a memory and a processor. FIG. 5A is a schematic structural diagram of the gimbal.

The memory is configured to store program codes and the processor is configured to call the program codes. When the program codes are executed, the processor is configured to perform obtaining a control parameter and a shooting range, obtaining an image amount according to the control parameter and the shooting range, determining shooting angles according to the shooting range and the image amount, and performing an image capture according to the shooting angle.

When obtaining the control parameters and the shooting range, the processor is specifically configured to obtain the control parameters and the shooting range from a control device, or obtain part or all of the control parameters from a shooting device and obtain the shooting range from the control device.

When obtaining the image amount according to the control parameters and the shooting range, the processor is specifically configured to determine an occupancy size of each frame of image according to a sensor type, a focal length, and an overlap ratio, determine a total size of the image according to the shooting range, and obtain the image amount according to the occupancy size of each frame of image and the total size of the image.

When determining the occupancy size of each frame of image according to the sensor type, the focal length and the overlap ratio, the processor is specifically configured to determine an actual size of each frame of image according to the sensor type and the focal length and determine the occupancy size of each frame of image according to the actual size of the image and the overlap ratio.

When determining the shooting angle according to the shooting range and the image amount, the processor is specifically configured to, if the shooting range includes a start shooting angle and a finish shooting angle, divide the angle between the start shooting angle and the finish shooting angle into the image amount of shooting angles.

When performing image capture according to the shooting angle, the processor is specifically configured to move the gimbal to the shooting angle and send a shooting command to the shooting device. The shooting command is used to make the shooting device to perform image capture at the shooting angle.

When moving the gimbal to the shooting angle, the processor is specifically configured to, if the control parameter also includes a delay time, move the gimbal to the shooting angle after the gimbal stays at the previous shooting angle for a period of the delay time.

When moving the gimbal to the shooting angle, the processor is specifically configured to sequentially move the gimbal to each of all the shooting angles according to a pause strategy.

A control device is provided according to an embodiment of the present disclosure. The control device includes a memory and a processor. FIG. 5B is a schematic structural diagram of the control device. The memory is configured to store program codes and the processor is configured to call the program codes. When the program codes are executed, the processor is configured to perform obtaining a control parameter and a shooting range of a shooting device, sending the control parameter and the shooting range to a gimbal so that the gimbal determines shooting angles according to the control parameter and the shooting range, and performing the image capture according to the shooting angles.

When obtaining the control parameters of the shooting device, the processor is specifically configured to display a control interface to a user and receive the control parameters input by the user on the control interface, and/or obtain part or all of the control parameters of the shooting device from the shooting device. When obtaining the shooting range, the processor is specifically configured to display a control interface to the user and receive the shooting range input by the user on the control interface, or obtain an actual shooting angle of the gimbal and determine the shooting range according to the actual shooting angle of the gimbal.

When obtaining the actual shooting angle of the gimbal, the processor is specifically configured to display a control interface, which includes a gimbal moving button, to a user, and obtain the actual shooting angle of the gimbal if an operation command for the gimbal moving button is received, or display a control interface, which includes a virtual joystick for controlling the shooting angle of the gimbal, to a user, and obtain the actual shooting angle of the gimbal if an operation command for the virtual joystick is received.

After obtaining the control parameters and the shooting range of the shooting device, the processor is further configured to obtain an image amount according to the control parameters and the shooting range and determine the shooting angle according to the shooting range and the image amount.

When obtaining the image amount according to the control parameters and the shooting range, the processor is specifically configured to determine an occupancy size of each frame of image according to a sensor type, a focal length, and an overlap ratio, determine a total size of the image according to the shooting range, and obtain the image amount according to the occupancy size of each frame of image and the total size of the image.

When determining the occupancy size of each frame of image according to the sensor type, the focal length and the overlap ratio, the processor is specifically configured to determine an actual size of each frame of image according to the sensor type and the focal length and determine the occupancy size of each frame of image according to the actual size of the image and the overlap ratio.

When determining the shooting angle according to the shooting range and the image amount, the processor is specifically configured to, if the shooting range includes a start shooting angle and a finish shooting angle, divide the angle between the start shooting angle and the finish shooting angle into the image amount of shooting angles.

After determining the shooting angle according to the shooting range and the image amount, the processor is configured to display a control interface, which includes a preview button, to the user, and control the shooting angle of the gimbal according to the shooting angle if a preview command for the preview button is received.

After determining the shooting angle according to the shooting range and the image amount, the processor is configured to obtain an adjusted shooting range if an adjustment command for the shooting range is received, and adjust the shooting range using the adjusted shooting range.

When obtaining the adjusted shooting range, the processor is specifically configured to display a control interface to a user and receive the adjusted shooting range input by the user on the control interface, and/or obtain the actual shooting angle of the gimbal and determine the adjusted shooting range according to the actual shooting angle of the gimbal.

When obtaining the actual shooting angle of the gimbal, the processor is specifically configured to display a control interface, which includes a gimbal moving button, to a user, and obtain the actual shooting angle of the gimbal if an operation command for the gimbal moving button is received, or display a control interface, which includes a virtual joystick for controlling the shooting angle of the gimbal, to a user, and obtain the actual shooting angle of the gimbal if an operation command for the virtual joystick is received.

A machine-readable storage medium is provided according to the embodiments of the present disclosure. Computer instructions are stored in the machine-readable storage medium. When the computer instructions are executed, the above-described image capture method is implemented.

The system, device, module or unit explained in the above embodiments may be realized by a computer chip or entity, or by a product with a certain function. A typical implementation device is a computer, and the specific form of the computer may be a personal computer, a laptop computer, a cellular phone, a camera phone, a smart phone, a personal digital assistant, a media player, a navigation device, an email sending and receiving device, a game console, a tablet computer, a wearable device, or any combination of these devices.

For the convenience of description, the above devices are described separately with various units divided based on the functions. When implementing the present disclosure, the functions of each unit may be implemented with one or more software and/or hardware.

Those skilled in the art should understand that the embodiments of the present disclosure may be provided as methods, systems, or computer program products. Therefore, the present disclosure can be performed by hardware, software, or a combination thereof. Furthermore, the embodiments of the present disclosure may be provided as computer program products implemented on one or more computer-readable storage media (including but not limited to a magnetic disk, a CD-ROM, an optical disk, etc.) containing computer executable programs.

The present disclosure is described with reference to the flowcharts and/or block diagram of the method, the device (system), and the computer program according to the embodiments of the present disclosure. Each step and/or block in the flowchart and/or block diagram and a combination of the step and/or block in the flowchart and/or block diagram may be implemented by computer program instructions. These computer program instructions can be provided to a general-purpose computer, a special-purpose computer and an embedded processor, or other programmable data processing device to generate a machine. So that a device for realizing the functions specified in one step or multiple steps of the flowchart and/or one block or multiple blocks of the block diagram can be generated by using the processor of the computer or other programmable data processing device to perform the instructions.

Moreover, these computer program instructions may be stored in a computer readable storage medium that can guide the computer or other programmable data processing device to work in a specific manner, so that a product including the instructions device can be generated with the instructions stored in the computer readable storage medium. The instruction device implements the functions specified in one step or multiple steps in the flowchart and/or one block or multiple blocks in the block diagram.

These computer program instructions can be stored in a computer or other programmable data processing device, so that a series of operating steps are performed on the computer or other programmable device to generate a computer-implemented processing. Thereby executing instructions on the computer or other programmable device provides steps for implementing the functions specified in one step or multiple steps of the flowchart and/or one block or multiple blocks of the block diagram.

The above are only example embodiments of the present disclosure and are not intended to limit the present disclosure. For those skilled in the art, the present disclosure may have various modifications and changes. Any modification, equivalent replacement, and improvement made within the principle of the present disclosure shall be included in the scope of the present disclosure.

What is claimed is:

1. An image capture method comprising:
obtaining one or more control parameters and a shooting range;
obtaining an image amount according to the one or more control parameters and the shooting range;
determining shooting angles according to the shooting range and the image amount; and
performing image capture according to the shooting angles.

2. The method of claim 1, wherein obtaining the one or more control parameters and the shooting range includes:
obtaining the one or more control parameters and the shooting range from a control device; or
obtaining part or all of the one or more control parameters from a shooting device and obtaining the shooting range from the control device.

3. The method of claim 1, wherein the one or more control parameters include at least one of a sensor type of a shooting device, a focal length, an overlap ratio, or a delay time.

4. The method of claim 3, wherein:
the one or more control parameters include the sensor type, the focal length, and the overlap ratio; and
obtaining the image amount according to the one or more control parameters and the shooting range includes:
determining a frame occupancy size according to the sensor type, the focal length, and the overlap ratio;
determining a total image size according to the shooting range; and
obtaining the image amount according to the frame occupancy size and the total image size.

5. The method of claim 1, wherein:
the shooting range includes a start shooting angle and a finish shooting angle; and
determining the shooting angles according to the shooting range and the image amount includes:
dividing an angle between the start shooting angle and the finish shooting angle into the shooting angles, a number of the shooting angles equaling the image amount.

6. The method of claim 5, wherein dividing the angle between the start shooting angle and the finish shooting angle into the shooting angles includes:
determining an angle difference between the finish shooting angle and the start shooting angle;
obtaining an average angle according to the angle difference and the image amount; and
obtaining the shooting angles according to the average angle.

7. The method of claim 1, wherein performing the image capture according to the shooting angles includes:
moving the gimbal to the shooting angles; and
sending a shooting command to a shooting device, the shooting command controlling the shooting device to perform image capture at the shooting angles.

8. The method of claim 7, wherein:
the one or more control parameters include a delay time;
moving the gimbal to the shooting angles includes:
in response to the gimbal having stayed at a previous shooting angle for a period equaling the delay time, moving the gimbal to a next shooting angle.

9. The method of claim 7, wherein moving the gimbal to the shooting angles includes sequentially moving the gimbal to each of the shooting angles according to a pause strategy.

10. The method of claim 7, wherein:
the gimbal is connected to the shooting device through a control line; and
sending the shooting command to the shooting device includes sending the shooting command to the shooting device through the control line.

11. The method of claim 1, wherein each of the shooting angles includes attitude information of the gimbal, the attitude information including at least one of a yaw attitude, a roll attitude, or a pitch attitude.

12. An image capture method comprising:
obtaining one or more control parameters and a shooting range of a shooting device; and
sending the one or more control parameters and the shooting range to a gimbal, so that the gimbal determines shooting angles according to the one or more control parameters and the shooting range and performs image capture according to the shooting angles.

13. The method of claim 12, wherein the one or more control parameters include at least one of a sensor type, a focal length, an overlap ratio, or a delay time.

14. The method of claim 12, wherein obtaining the one or more control parameters of the shooting device includes at least one of:
displaying a control interface and receiving the one or more control parameters input by on the control interface; or
obtaining part or all of the one or more control parameters from the shooting device.

15. The method of claim 12, wherein obtaining the shooting range includes:
displaying a control interface; and
receiving the shooting range input on the control interface.

16. The method of claim 12, wherein obtaining the shooting range includes:
obtaining an actual shooting angle of the gimbal; and
determining the shooting range according to the actual shooting angle of the gimbal.

17. The method of claim 12, further comprising, after obtaining the one or more control parameters and the shooting range:
obtaining an image amount according to the one or more control parameters and the shooting range; and
determining the shooting angles according to the shooting range and the image amount.

18. The method of claim 12, further comprising:
displaying a control interface including a real-time position of the shooting device.

19. The method of claim 12, wherein each of the shooting angles includes attitude information of the gimbal, the attitude information including at least one of a yaw attitude, a roll attitude, or a pitch attitude.

20. A gimbal comprising:
a memory storing program codes; and
a processor configured to call the program codes to:
obtain one or more control parameters and a shooting range;
obtain an image amount according to the one or more control parameters and the shooting range;
determine shooting angles according to the shooting range and the image amount; and
perform image capture according to the shooting angle.
